(19) United States
(12) Patent Application Publication
(10) Pub. No.: US 2006/0153388 A1
(43) Pub. Date: Jul. 13, 2006

(54) Integrated and monolithic package structure of acoustic wave device

(76) Inventors: Yu-Tung Huang, Tao-Yuan (TW); Ken-Huang Lin, Kaohsiung City (TW); Ming-Hung Chang, Tao-Yuan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/033,637

(22) Filed: Jan. 13, 2005

(51) Int. Cl. H04L 9/00

(52) U.S. Cl. 380/279

(57) ABSTRACT

An integrated and monolithic package structure of acoustic wave device is provided that includes a first device, a conjunction layer, a second device and a conductive layer. The first device is placed in a way of face up, the second device is placed in a way of face down, and the conjunction layer is placed between the first device and second device so as to form the structure of acoustic wave device. Due to the fact that the conductive layer is formed at least on one side of the device thereof, the thermal effect and electromagnetic feed-through can be reduced. The encapsulation package technology, air cavity package technology, and a package of the multi-layer structure, including a space layer, a chip contact layer, and a circuit board, are provided to protect the acoustic device and the conductive layer at the lateral sides of the acoustic device from the destroying due to the humidity and the mechanical destroying coming from the external environment.

### BACKGROUND OF THE INVENTION

1. Field of the Invention

The present invention relates to a package structure of an acoustic wave device, and more particularly to an integrated and monolithic package structure of an acoustic wave device and a structure of an acoustic wave device with a conductive layer formed on the lateral side of the device.

2. Description of the Prior Art

In the fast growing communication industry, communication products trend toward the multi-function, low-price, lightweight, small-size, and low-power targets. Miniaturizing the circuit is the only way to achieve the target. Taking an acoustic wave device as an example, a surface acoustic wave filter (SAW filter) plays an important role in communication passive devices. Its operation concept is to filter by adopting surface acoustic wave. Because the speed of the acoustic wave is slower than the speed of the electromagnetic wave, the SAW filter can be shrunk more effectively than microstrip line filter or radio link control filter in the same radio frequency filter device. Producing an inter-digital transducer (IDT) by depositing metal on a piezoelectric substrate can make the electric signals and mechanic energy convert each other to allow the device to have the characters of filtering and resonating.

Having a high quality factor and frequency stability, and possessing the advantages of small size, light weight, compatibility with IC manufacturing processes, the SAW filters are employed broadly in the designs of filters, duplexers, and resonators in wireless communications. So far, the developed surface acoustic devices cover the operation frequencies from 10 MHz and 3 GHz, and are employed in transmitting/receiving radio frequency signals, signal processing, television signal, satellite communication, and radar systems etc. Besides, having the characters of high sensitivity, high signal/noise ratio, and high resonant frequency, the surface acoustic devices can also be applied in manufacturing conventional sensors.

So far, the trend of wireless communication is “light, thin, short, small”. Therefore, the main goal of developing acoustic wave devices is to miniaturize. But miniaturizing causes some negative effects on the devices' functions. For example, because the integration of the devices increases, there is cross talk due to the electromagnetic interference among devices, and the integration of the signals are affected. Besides, because the operation frequency increases, the parasitic capacitance effect is produced in conventional package process, such as wire bonding. Furthermore, because of both the integration of the devices and the operation frequency increase, the passive devices produce thermal effect, especially for the devices on the transmission terminals due to the higher operation power than the receiving terminals.

### SUMMARY OF THE INVENTION

Accordingly, the present invention provides an integrated package structure of acoustic wave devices. One of the objects is to provide electromagnetic shielding to prevent cross talk and decrease thermal effect by forming a conductive layer at least at one lateral side of the acoustic wave device of the present invention.

Another object of the present invention is to provide a monolithic package structure of acoustic wave devices by stacking multiple devices vertically on a single substrate to reduce the planar space of the package structure of the present invention. And there is a conductive layer formed at least at a side of the stacked device. Therefore, it can achieve the great result of electromagnetic shielding, and reduce the thermal effect, electromagnetic interference and cross talk.

According to the objects mentioned above, the present invention provides an integrated package structure of an acoustic wave device structure, including a first device, a conjunction layer, a second device, a conductive layer and a shell. The first device has a plurality of electrodes in a surface. The conjunction layer attaches the surface without the electrodes of the first device. The second device has a plurality of electrodes electrically connected with a circuit board, and the surface without the electrodes of the second device attaches the conjunction layer to form the structure of the acoustic wave device. The conductive layer is vertically formed at least at a lateral side of the acoustic device. The shell is to seal the acoustic device and the conductive layer.

Secondly, the present invention provides a monolithic package structure of an acoustic device, including a substrate, a conductive layer, and a shell. The substrate has a first electrode on the top surface, and a second electrode on the bottom surface. Both the first and second electrodes are electrically connected with a circuit board. The conductive layer is formed at least at a lateral side of the substrate. The shell and the circuit board seal the substrate and the conductive layer.

### BRIEF DESCRIPTION OF THE DRAWINGS

The accompanying drawings incorporated in and forming a part of the specification illustrated several aspects of the present invention, and together with the description serve to explain the principles of the invention. In the drawings:

FIG. 1 shows a conjunction layer is formed on a device with electrodes and electrode pads.

FIG. 2 the flip-chip technology is employed to connect another device with a circuit board.

FIG. 3 shows a back-to-back structure.

FIG. 4 shows grounding in wire-bonding technology for the acoustic wave device structure.

FIG. 5 shows a conductive layer is dispensed at least at one side of the acoustic wave device structure.

FIG. 6 shows a metal plating layer is formed at the both lateral sides of the acoustic wave device structure.

FIG. 7 shows both the conductive adhesive layer and the metal plating layer are formed for the acoustic wave device structure to reduce the electromagnetic interference and thermal effect.

FIG. 8-11 are the structure diagrams in accordance with the embodiments of the present invention in air cavity package technology.

FIG. 12-15 are the structure diagrams in accordance with the embodiments of the present invention in encapsulation package technology.

FIG. 16 shows a metal air bridge over the electrodes of the device provided for protection and electromagnetic shielding of the electrodes in the preferred embodiment of the present invention.

FIG. 17-21 are the structure diagrams in accordance with the embodiments of the present invention in monolithic package structure.

### DESCRIPTION OF THE INVENTION

The following is the detailed description of the present invention. The following description for the manufacturing process and structure do not include the entire process of manufacturing. The adopted skills of the present invention are to be recited roughly when needed to help explicate the present invention.

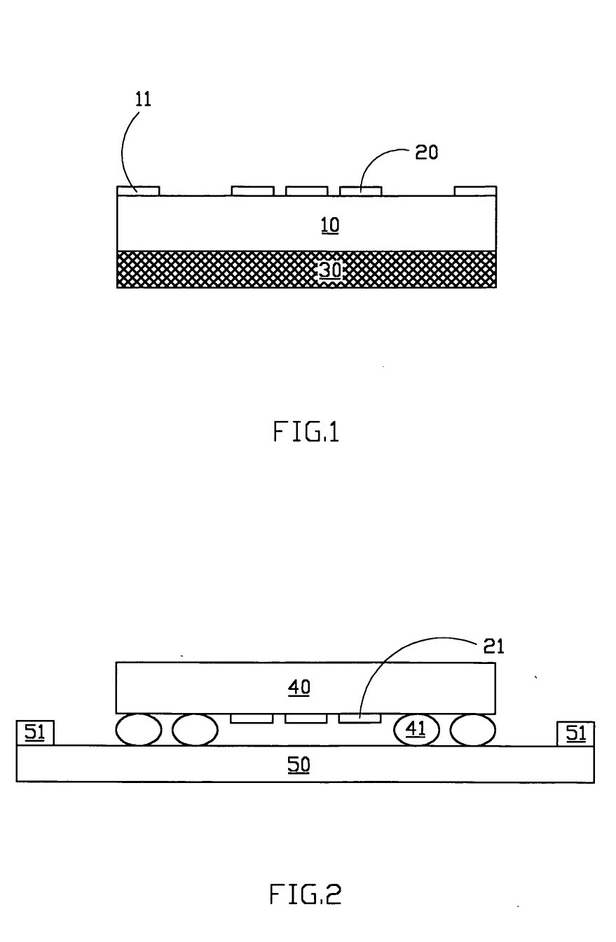

Referring to FIG. 1, a preferred embodiment of the present invention, a device 10, such as an acoustic wave device, has electrodes 20 and electrode pads 11 on a surface. The device 10 may have the functions to receive or transmit. When having both the receiving and transmitting functions, the device 10 may form a duplexer. A conjunction layer 30 is formed on the surface of the device 10 behind the electrodes 20. The conjunction layer 30 may be electric or thermal conduction material. The electric or thermal-conductive materials include metal, such as single metal layer, alloy, and multi-layer metal structures. They may also include an electric- or thermal-conductive substrate, such as a silicon substrate and a sapphire substrate. Or the electric or thermal conduction colloid, such as adhesive, can be employed as the conjunction layer 30.

The way to form the conjunction layer 30 on the surface of the device 10 includes film deposition technology, such as physical vapor deposition (PVD), chemical vapor deposition (CVD), or plating, to attach the electric or thermal conduction materials on the surface of the device 10 directly. The general interface bonding technologies, such as surface mounting technology (SMT), adhesive bonding, or wafer bonding, are employed to bond the device 10 and the conjunction layer 30 together.

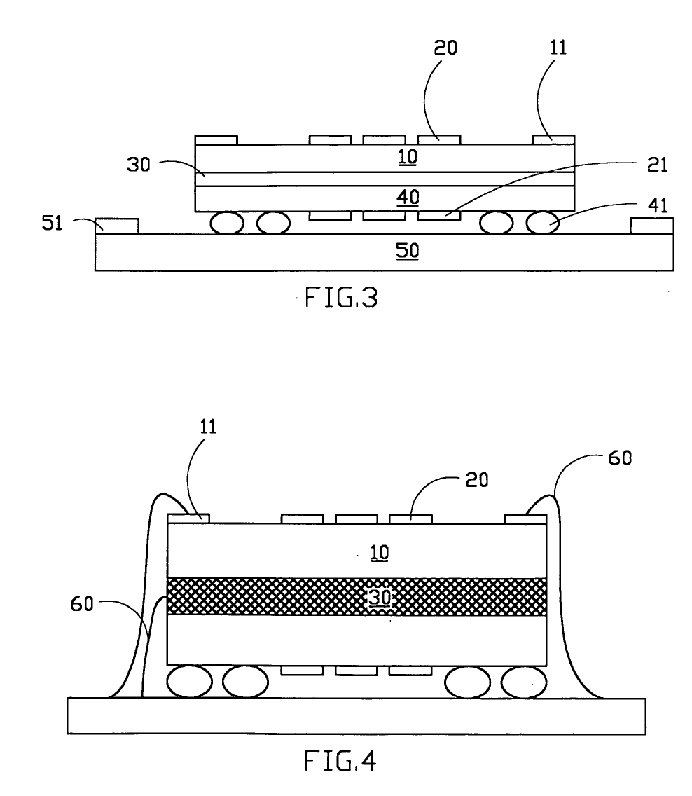

Then, referring to FIG. 2, another device 40, such as an acoustic wave device, has electrodes 21 on a surface facing and electrically connected with the circuit board 50. The device 40 may have the functions to receive or transmit. When having both the receiving and transmitting functions, the device 40 may form a duplexer. In the present invention, the flip-chip technology is employed, so that the respective contacts of the electrodes 21 of the device 40 are electrically connected with the circuit board 50 through a plurality of metal balls 41, such as gold bumps or solder bumps, in thermal-sonic bonding, solder bonding, anisotropic conductive film (past) bonding or conductive adhesive bonding technology to achieve circuit connection. Generally, the height of the metal balls 41 is tens of micro meter (μm). Because the device 10 faces down to the circuit board 50, and the electrodes 21 are directly connected with the circuit board 50 by the metal balls 41, the distance of signal transport can be effectively reduced. Comparing with the conventional package technologies, the present invention can shrink the packed volume, and also reduce the signal transport and the generation of noise. In the embodiment, the circuit board 50 may be a multi-layer printed circuit board or ceramic substrate. The circuit board 50 may also include a plurality of circuitries or conductive pads 51 formed on a surface.

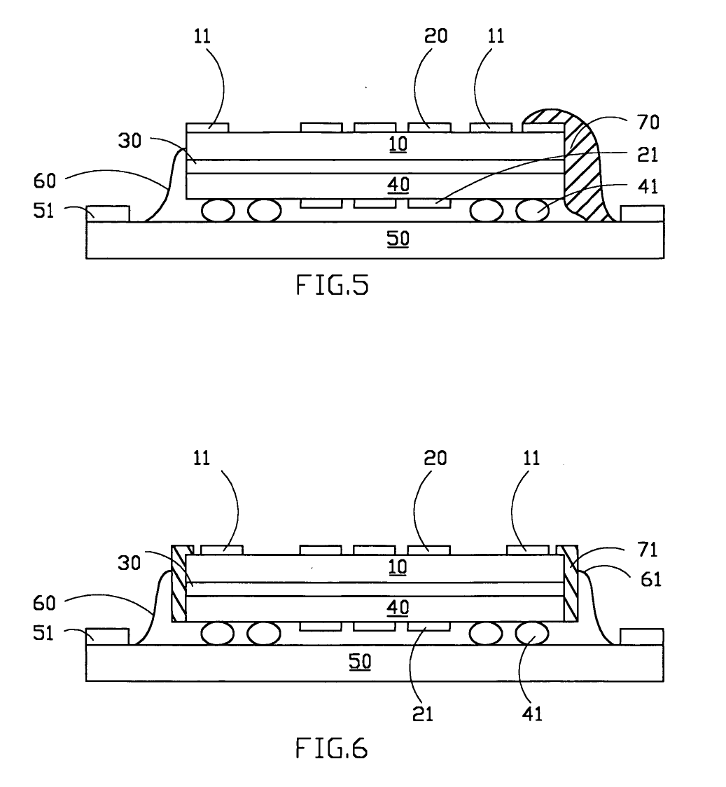

Next, referring to FIG. 3, the general interfaces bonding technologies, such as surface mounting technology (SMT), adhesive bonding, or wafer bonding, are employed to bond the device 10 and the device 40 back-to-back together through the conjunction layer 30. Alternatively, the conjunction layer 30 may be formed on the surface of the device 40 behind the electrodes 21 first, and then bonded with the surface of the device 10 behind the electrodes 20 by the interface bonding technologies as those mentioned above. The device 10 and the device 40 may be surface acoustic wave devices, bulk acoustic wave devices or thin film acoustic wave devices.

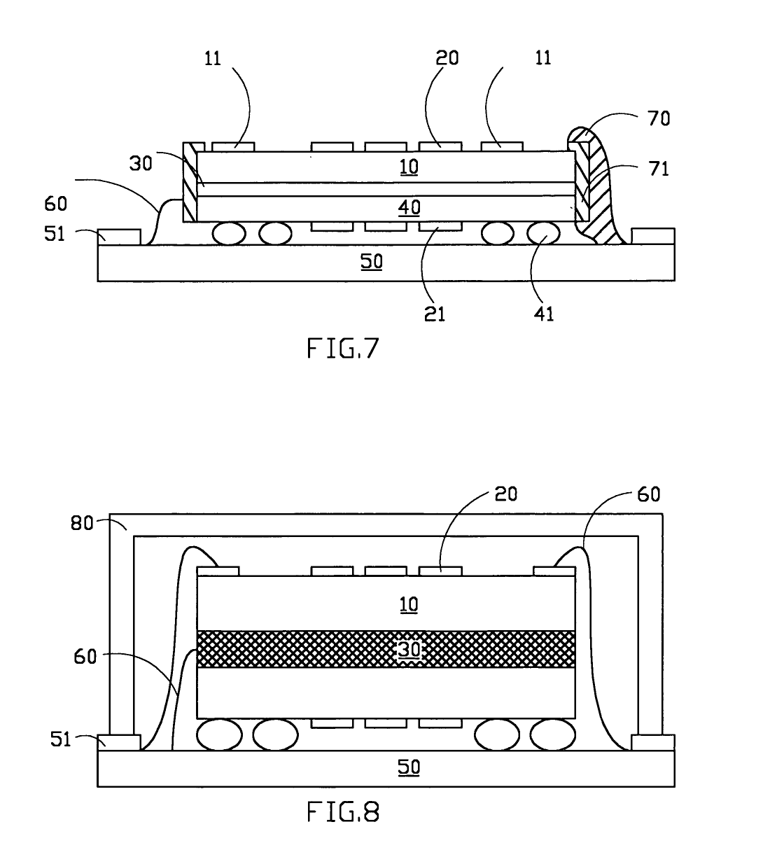

After that, referring to FIG. 4, the electrodes 20 of the device 10 and the conjunction layer 30 are connected with the circuit board 50 in the wire-bonding technology through wires 60. Generally speaking, the connection of the wires 60 has to provide sufficient grounding. The wires 60 are close to each other as possible as they can to reduce the area of the circuit. Metal wires are applied to connect the electrode pads 11 of the device 10 and the circuit board 50 in wire-bonding technology, and general package technologies are adopted.

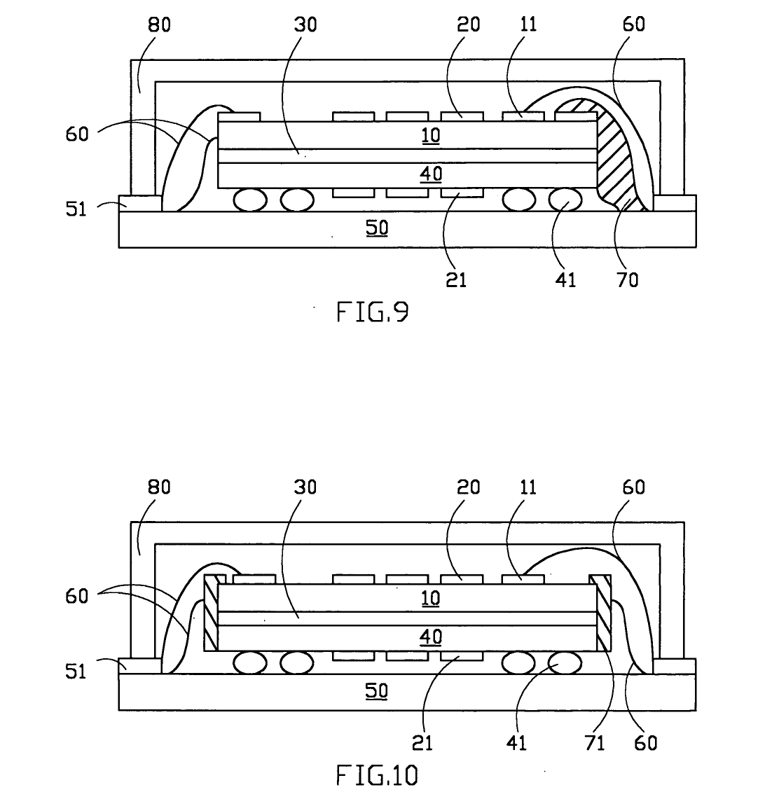

Or, referring to FIG. 5, which is succeeded to FIG. 3, a conductive layer may be dispensed at least at one side of the acoustic wave device structure including the device 10, the conjunction layer 30, and the device 40. The conductive layer may be a conductive adhesive layer 70. The material of the conductive adhesion layer 70 includes the high electric or thermal conduction material, such as conductive silver adhesive, thermal adhesive, or silicone. The conductive adhesion layer 70 may contact with the conjunction layer 30, and contact with circuit board 50 from one end to form a thermal conduction path. When the conductive adhesive layer 70 is formed only at one side, a metal wire, the wire 60, may connect the conjunction layer and contact with the circuit board 50 in wire-bonding technology to work as another thermal conduction path at another side. Because the conductive adhesive layer 70 contacts with the conjunction layer 30 and one end of the conductive adhesive layer 70 contacts with the circuit board 50 to form a thermal conduction path, it is an alternative method in manufacturing process to employ the wire 60 to connect the conjunction layer 30 and contact with the circuit board 50 to form another thermal conduction path.

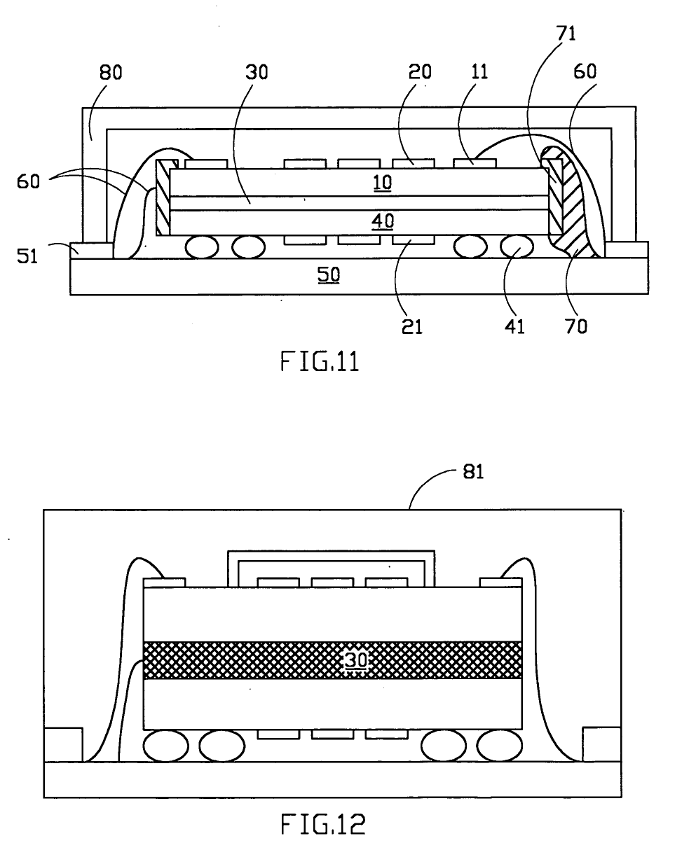

Alternatively, referring to FIG. 6, which is also succeeded to FIG. 3, vertically forming a metal plating layer 71 at the both lateral sides of the acoustic wave device structure including the device 10, the conjunction layer 30, and the device 40 in vaporizing, sputtering or plating method. The metal plating layer 71 may be general metal material, such as titanium/aluminum, titanium/copper, or chromium/silver. The mentioned materials above do not limit the present invention. Any material with high electrical and thermal conductivity is included in the scope of the present invention. The metal plating layer 71 provides better electromagnetic shielding for the acoustic wave devices, and works as a thermal conduction path by contacting with the conjunction layer 30 and the circuit board 50 through the conjunction wire 61.

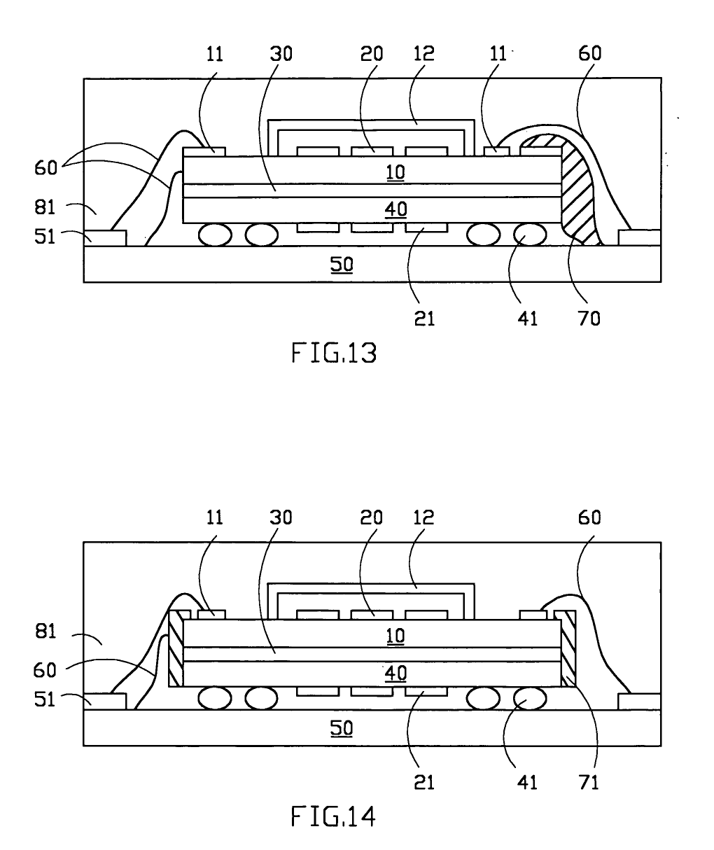

The present invention may further provide a conductive adhesive layer 70 formed on the metal plating layer 71 at one of the two lateral sides, as shown in FIG. 7. The electric and thermal conduction characters of the conductive adhesive layer 70 and the metal plating layer 71 provide the electromagnetic shielding and increase the power durability by solving the problem of thermal effect introduced through the high integration of the devices operating at high frequency for modern wireless application. The mentioned materials above do not limit the present invention. Any material with high electrical and thermal conductivity is included in the scope of the present invention. Then, the plurality of the respective electrode contacts of the electrodes 21 on the device 40 electrically connects the circuit board 50 in flip-chip bonding technology. The thermal-sonic bonding, solder bonding, anisotropic conductive film (past) bonding or conductive adhesive bonding technology is adopted for connecting the metal balls 41, such as the gold bump or solder bump, with the surface of the circuit board 50 to achieve the circuit connection. Because the conductive adhesive layer 70 and the metal plating layer 71 contacts with the conjunction layer 30 and one end of the conductive adhesive layer 70 contacts with the circuit board 50 to form a thermal conduction path, it is an alternative method in manufacturing process to employ the wire 60 to connect the conjunction layer 30 and contact with the circuit board 50 to form another thermal conduction path.

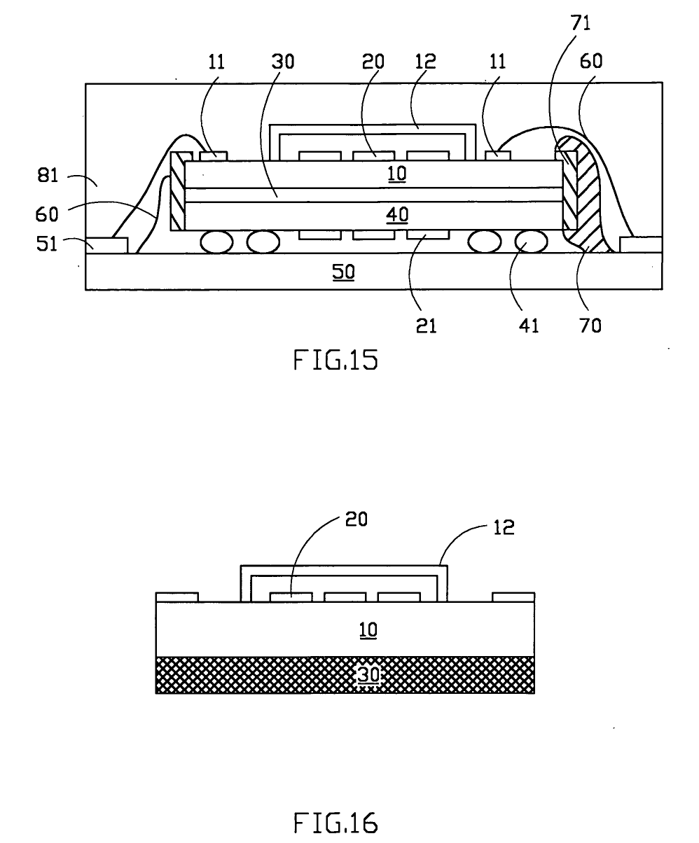

Next, as shown in FIG. 8 to FIG. 11, wires 60 are employed to electrically connect the electrode pads 11 on the surface of the device 10 with a plurality of the conductive pads 51 of the circuit board 50 in wire-bonding technology. Generally speaking, the connection of the wires 60 provides sufficient grounding. After finishing the wire-bonding process, the shell 80 is provided for an air cavity package structure to protect the acoustic device from the destroying due to the humidity and the mechanical destroying coming from the external environment. The material of the shell 80 may consist of metal, ceramic, or plastic. The air cavity package structure can provide a hermetic sealing result to block water, and have a better thermal conduction character and an electromagnetic shielding function.

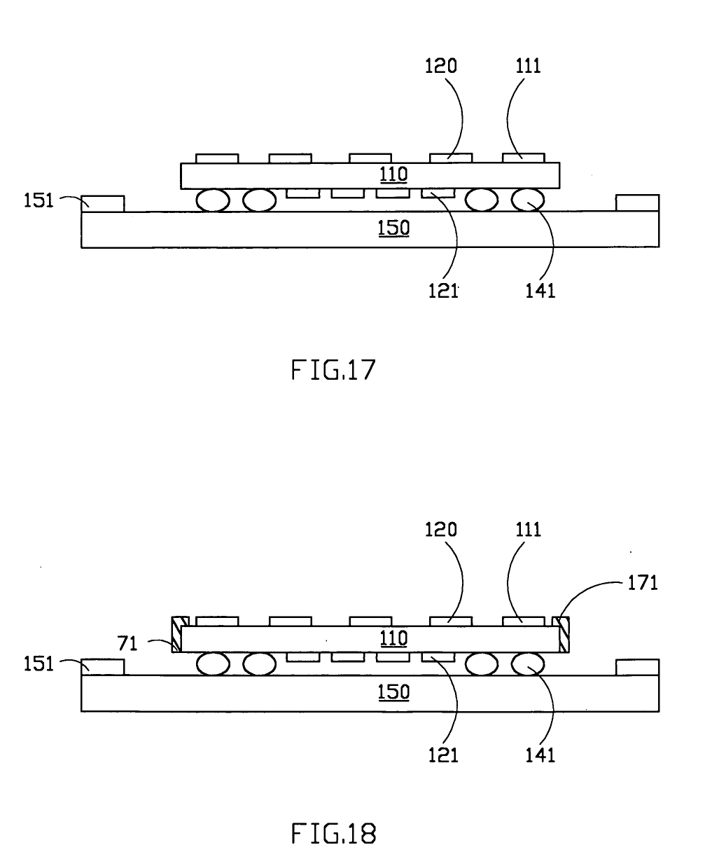

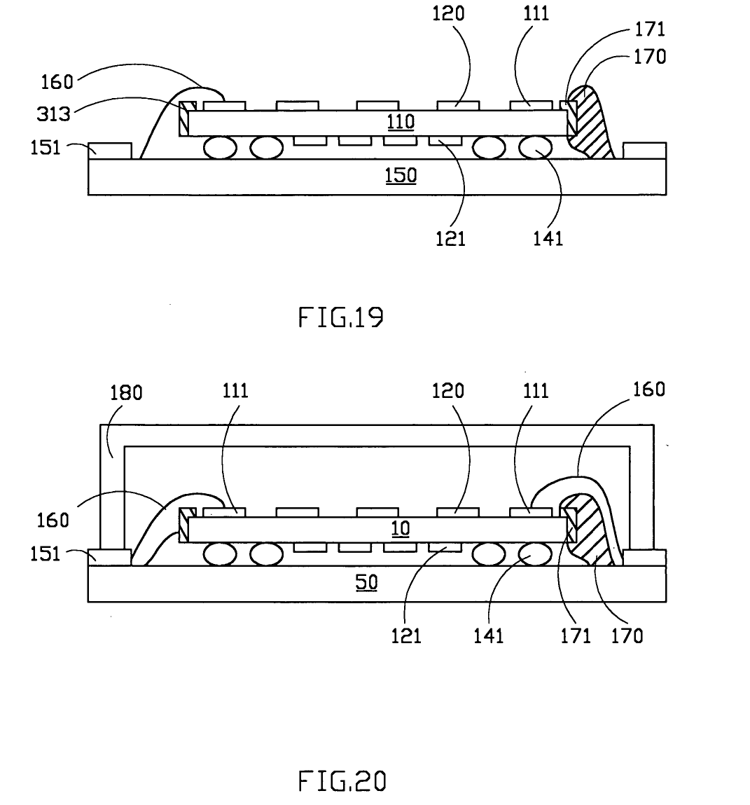

The content of the present invention can be explicated by the following preferred embodiment and the associated drawings, FIG. 12 to FIG. 15. The preferred embodiment has a similar structure as the first preferred embodiment mentioned above. The difference, referring to FIG. 16, is there is a metal air bridge 12 over the electrodes 20 of the device 10 provided by an air bridge process for protection and electromagnetic shielding of the electrodes 20 in the preferred embodiment. The following steps to accomplish the preferred embodiment are the same as the steps mentioned above to accomplish the first embodiment before providing a shell. Another difference from the mentioned preferred embodiment above is to adopt the molding compound package 81 instead of the air cavity package for providing a shell. The metal air bridge 12 over the electrodes 20 of the device 10 is formed in the lithography process. The metal air bridge 12 is a humpback-like shape. The material of the metal air bridge 12 may be titanium/gold or other metal material.

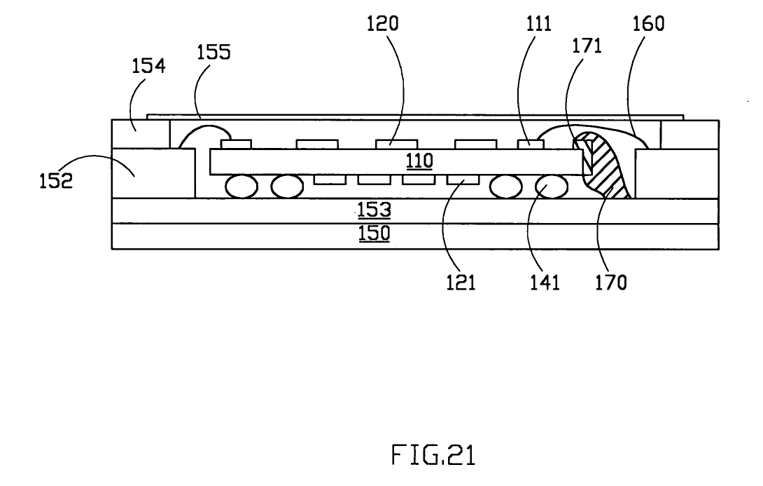

Besides, for further shortening the height of the acoustic wave device structure, the present invention provides a monolithic package structure. It can be explicated by the following preferred embodiment and the associated drawings, FIG. 17 to FIG. 21. At first, referring to FIG. 17, a substrate 110 is provided. The top and bottom surfaces of the substrate 110 are piezoelectric monolithic wafer that is dual-surface processed, or each of the both surfaces is a silicon chip that is epitaxially processed to form a piezoelectric epitaxial layer (not shown). However, the present invention does not limit the substrate to adopt the silicon chip only. Any material that can form an oxide layer on the substrate 110 is included in the scope of the present invention. Next, a plurality of the electrodes 120 and their respective electrode contracts 111 are formed on a surface in a conventional metal film manufacturing process, and then the surface with the electrodes is covered by an organic material, such as photo resist or polyimide. After that, the substrate 110 is turned over to form a plurality of electrodes 121 on the bottom surface, and then the flip-chip technology is applied for electrically connecting the electrodes 121 on the bottom surface electrically with a circuit board 150 through a plurality of metal balls 141, such as gold bumps or solder bumps, in thermal-sonic bonding, solder bonding, anisotropic conductive film (past) bonding or conductive adhesive bonding technology. The circuit board 150 provided in the present invention may be a multi-layer printed circuit board or ceramic substrate. The circuit board 150 includes a plurality of conductive pads 151, and may also have a plurality of circuitries formed on a surface. Because of adopting flip-chip technology, the distance of the signal transport can be reduced effectively. And because of adopting the device structure of the monolithic chip, the vertical space of the device structure can be reduced effectively.

Besides, as shown in FIG. 18, after forming the electrodes 120 on the top surface and electrodes 121 on the bottom surface of the substrate 110, a metal plating layer 171, such as titanium/aluminum, titanium/copper, chromium/silver etc., may be formed at least at one lateral side of the substrate 110. The materials mentioned above are not limited in the present invention. Any material with high electrical and thermal conductivity is included in the scope of the present invention. The metal plating layer 171 is a great shielding and conductive layer to provide the effect of the electromagnetic shielding. Therefore, the cross talk caused by the electromagnetic interference due to the increasing integration of devices can be avoided.

Same as the mentioned two preferred embodiments above, the present invention is not limited in providing metal plating 171 for substrate 150. A conductive adhesive layer 170 may also be formed on a metal plating layer 171 at a lateral side of the substrate 150, as shown in FIG. 19. The material of the conductive adhesive layer 170 may be silver adhesive or silicone, but not limited to the mentioned materials above. Any material with high electrical and thermal conductivity is included in the scope of the present invention. Because the conductive adhesive layer 170 contacts with the metal plating layer 171 and one end of the conductive adhesive layer 170 contacts with the circuit board 150 to form a thermal conduction path, it is an alternative method in manufacturing process to employ the wire 160 to connect the metal plating layer 171 and contact with the circuit board 150 to form another thermal conduction path.

Subsequently, referring to FIG. 20, wire-bonding technology is employed, such as the usage of the metal wire 160, to electrically connect the electrode pads 111 on the surface of the substrate 150 with a plurality of the conductive pads 151 of the circuit board 150. After finishing the wire-bonding process, the shell 180 is provided for an air cavity package structure to protect the substrate 110 from the destroying due to the humidity and the mechanical destroying coming from the external environment. The material of the shell 180 may consist of metal, ceramic, or plastic. The air cavity package structure can provide a hermetic sealing result to block water, and have a better thermal conduction character and an electromagnetic shielding function. Same as the mentioned two preferred embodiments above, the present invention may also provide a metal air bridge (not shown), in the air bridge process, over the electrodes 120 of the substrate 110 for protection. In this situation, the encapsulation package structure (not shown) is formed with resin outside the substrate 110 and the lateral conductive layer.

The present invention is not limited to employ a plurality of the electrodes 151 on the surface of the circuit board 150 to electrically connect a plurality of the electrode pads 111. Referring to FIG. 21, the present invention provides a package of the multi-layer structure, including a space layer 152, a chip contact layer 153, and a circuit board 150. The materials of the package of the multi-layer may be high temperature co-fired ceramic, low temperature co-fired ceramic, or multi-layer printed circuit board. The metal wires 160 are employed to connect package of the multi-layer and the electrode pads 111 of the substrate 150 to achieve the circuitry connection. The height of the space layer 152 of the package is the same as the height of the substrate 110. Besides, the top part 155 and the support 154 under the top part 155 are provided. The support 154 is a structure to locate the top part 155 above itself. Because the top part 155 is the most external part of the present invention, it can protect the acoustic wave device. The material of the top part 155 may be the metal lid, ceramic cap, or plastic cap. In addition, the die-attach layer 153 is provided on the top of the circuit board 150. The electrodes 120 on the bottom face of the substrate 110 connects the surface of the die-attach layer 153 to achieve the electrical connection through a plurality of the metal balls 141 in flip-chip technology, as shown in FIG. 21. Finally, the package structure of the acoustic wave device of the present invention is finished.

Because the present invention employs the flip-chip technology, it can decrease the distance of the signal transport effectively, and reduce the vertical space of the package structure to achieve the required trend, “light, thin, short, small”, for the devices. Further, the present invention provides a conductive layer with high thermal and electric conductivities at least at one side of the acoustic wave device, which is a great electromagnetic shielding layer and conductive layer, to accomplish the great electromagnetic shielding result. Therefore, the cross talk produced among the devices caused by the electromagnetic interference due to the increasing integration of the devices can be avoided. Besides, because of the character of the thermal conduction, the heat produced by the device can be transported to the substrate to decease the thermal effect due to the increasing integration of the devices.

While the described embodiment represents the preferred form of the present invention, it is to be understood that modifications will occur to those skilled in that art without departing from the spirit of the invention. The scope of the invention is therefore to be determined solely by the appended claims.

What is claimed is:

1. An integrated package structure of an acoustic wave device, comprising:
a first device with a first electrode on one side thereof, wherein the first electrode electrically connects with a circuit board;
a conjunction layer with a first surface fixed on the other side of the first device;
a second device with a second electrode on one side thereof, and the other side of the second device fixed on a second surface of the conjunction layer, wherein the second electrode electrically connects with the circuit board, and the second device connects with the first device through the conjunction layer to form the acoustic wave device structure;
a conductive layer vertically formed at least at a sidewall of the acoustic wave device structure; and
a shell to seal the acoustic wave device structure and the conductive layer with the circuit board.

2. The integrated package structure of an acoustic wave device according to claim 1, wherein the conjunction layer comprises metal.

3. The integrated package structure of an acoustic wave device according to claim 1, wherein the conjunction layer comprises electric- or thermal-conductive colloid.

4. The integrated package structure of an acoustic wave device according to claim 1, wherein the conjunction layer comprises an electric- or thermal-conductive substrate.

5. The integrated package structure of an acoustic wave device according to claim 1, wherein the conjunction layer is formed in a physical vapor deposition (PVD) method at the other side of the first device or other side second of the second device.

6. The integrated package structure of an acoustic wave device according to claim 1, wherein the conjunction layer is formed in a chemical vapor deposition (CVD) method at the other side of the first device or other side second of the second device.

7. The integrated package structure of an acoustic wave device according to claim 1, wherein the conjunction layer is formed in a plating method at an end behind the first electrode of the first device or an end behind the second of the second device.

8. The integrated package structure of an acoustic wave device according to claim 1, wherein the conjunction layer is fixed on the first device or second device in a surface mounting technology (SMT).

9. The integrated package structure of an acoustic wave device according to claim 4, wherein the electric- or thermal-conductive substrate comprises a silicon substrate.

10. The integrated package structure of an acoustic wave device according to claim 4, wherein the electric- or thermal-conductive substrate comprises a sapphire substrate.

11. The integrated package structure of an acoustic wave device according to claim 1, wherein the conjunction layer is fixed on the first device or second device in a wafer bonding technology.

12. The integrated package structure of an acoustic wave device according to claim 3, wherein the conductive colloid comprises adhesive.

13. The integrated package structure of an acoustic wave device according to claim 1, wherein the first device electrically connects the circuit board in a wire bonding technology.

14. The integrated package structure of an acoustic wave device according to claim 1, wherein the second device electrically connects the circuit board in a flip chip bonding technology.

15. The integrated package structure of an acoustic wave device according to claim 1, wherein the conductive layer is formed by forming a metal plating layer in a film coating process at least at a sidewall of the acoustic wave device structure.

16. The integrated package structure of an acoustic wave device according to claim 1, wherein the conductive layer is formed by an electric-conductive material in a dispensing process, and electrically connects with the circuit board.

17. The integrated package structure of an acoustic wave device according to claim 15, wherein the conductive layer is formed by the electric conduction material in a dispensing process to contact with the metal plating layer, and electrically connects with the circuit board.

18. The integrated package structure of an acoustic wave device according to claim 15, wherein a metal wire electrically connects the conjunction layer with the circuit board from another sidewall of the acoustic wave device structure.

19. The integrated package structure of an acoustic wave device according to claim 1, further comprising a metal air bridge over the first electrode.

20. The integrated package structure of an acoustic wave device according to claim 1, wherein the material of the shell comprises metal.

21. The integrated package structure of an acoustic wave device according to claim 1, wherein the material of the shell comprises plastic.

22. The integrated package structure of an acoustic wave device according to claim 1, wherein the material of the shell comprises ceramic.

23. The integrated package structure of an acoustic wave device according to claim 1, wherein the shell is formed in an encapsulation package technology.

24. The integrated package structure of an acoustic wave device according to claim 1, wherein the shell is formed in an air cavity package technology.

25. The integrated package structure of an acoustic wave device according to claim 1, wherein the first device and the second device comprise acoustic wave devices.

26. The integrated package structure of an acoustic wave device according to claim 25, wherein the acoustic wave devices comprise surface acoustic wave devices.

27. The integrated package structure of an acoustic wave device according to claim 25, wherein the acoustic wave devices comprise bulk acoustic wave devices.

28. The integrated package structure of an acoustic wave device according to claim 25, wherein the acoustic wave devices comprise film bulk acoustic wave devices.

29. The integrated package structure of an acoustic wave device according to claim 25, wherein the first device comprises an acoustic wave device with a transmitting function and the second device comprises an acoustic wave device with a receiving function.

30. The integrated package structure of an acoustic wave device according to claim 25, wherein the first device comprises an acoustic wave device with a receiving function and the second device comprises an acoustic wave device with a transmitting function.

31. A monolithic package structure of an acoustic wave device, comprising:
a substrate with a first electrode on a top surface and a second electrode on a bottom surface, wherein the first electrode and the second electrode electrically connect with a circuit board;
a conductive layer formed at least at a side of the substrate; and
a shell to seal the substrate and the conductive layer with the circuit board.

32. The monolithic package structure of the acoustic wave device according to claim 31, wherein the substrate is a monolithic piezoelectric chip processed on the top and bottom surface.

33. The monolithic package structure of the acoustic wave device according to claim 31, wherein the substrate is an epitaxial silicon chip.

34. The monolithic package structure of the acoustic wave device according to claim 31, wherein the first electrode electrically connects the circuit board in wire bonding technology.

35. The monolithic package structure of the acoustic wave device according to claim 31, wherein the second electrode electrically connects the circuit board in flip-chip technology.

36. The monolithic package structure of the acoustic wave device according to claim 31, wherein the conductive layer is formed by a metal plating process at least at a sidewall of the substrate.

37. The monolithic package structure of the acoustic wave device according to claim 31, wherein an electric conduction material is formed at least at a side of the substrate in a dispensing process, and electrically connects with the circuit board.

38. The monolithic package structure of the acoustic wave device according to claim 36, wherein the electric conduction material contacts with the metal plating layer in the dispensing process, and electrically connects with the circuit board.

39. The monolithic package structure of the acoustic wave device according to claim 31, wherein a wire electrically connects another side of the substrate and the circuit board.

40. The monolithic package structure of the acoustic wave device according to claim 31, further comprising a metal air bridge over the first electrode.

41. The monolithic package structure of the acoustic wave device according to claim 31, wherein a material of the shell comprises metal.

42. The monolithic package structure of the acoustic wave device according to claim 31, wherein the material of the shell comprises plastic.

43. The monolithic package structure of the acoustic wave device according to claim 31, wherein the material of the shell comprises ceramic.

44. The monolithic package structure of the acoustic wave device according to claim 31, wherein a material of the substrate comprises silicon.

45. The monolithic package structure of the acoustic wave device according to claim 31, further comprising a plurality of conductive pads on the surface of the circuit board.

46. The monolithic package structure of the acoustic wave device according to claim 31, wherein the material of the circuit board comprises low-temperature ceramic.

47. The monolithic package structure of the acoustic wave device according to claim 31, wherein a material of the circuit board comprises high-temperature ceramic.

48. The monolithic package structure of the acoustic wave device according to claim 31, wherein a material of the circuit board comprises multi-layer printed circuit board.

49. The monolithic package structure of the acoustic wave device according to claim 31, wherein the shell is formed in an encapsulation package technology.

50. The monolithic package structure of the acoustic wave device according to claim 31, wherein the shell is formed in an air cavity package technology.
